(19) United States
(12) Patent Application Publication
(10) Pub. No.: US 2015/0091339 A1
(43) Pub. Date: Apr. 2, 2015

(54) COOLING LINER

(71) Applicant: Chris Richard Bomhard, Clearwater, FL (US)

(72) Inventor: Chris Richard Bomhard, Clearwater, FL (US)

(21) Appl. No.: 14/040,717

(22) Filed: Sep. 29, 2013

(51) Int. Cl. B60N 2/56; A47C 7/74

(52) U.S. Cl. CPC B60N 2/5614; A47C 7/744
USPC 297/180.11

(57) ABSTRACT

A liner for a car seat, stroller seat or other similar seat for a child can have cool water circulating therethrough to help keep the child cool. The liner includes a tube disposed throughout the liner that is interconnected to a cooling chamber. A pump, typically disposed in the cooling chamber, can be used to circulate the cool fluid through the tube in the liner.

### BACKGROUND OF THE INVENTION

The present invention relates to cooling liners and, more particularly, to a liner for a baby car seat, stroller, or the like, that can keep a baby cool.

While sitting in a baby seat or stroller, there are limited ways to keep the child cool. Currently, only fans are available to blow ambient air on the child to cool them. This can be ineffective for cooling the child when the ambient air is warm.

As can be seen, there is a need for a method and apparatus for keeping a child cool when seated in a car seat, stroller or the like.

### SUMMARY OF THE INVENTION

In one aspect of the present invention, a cooling system comprises a liner for placement under a user; a hose interwoven throughout the liner; a cooling chamber for containing a cool fluid; a supply tube delivering the cool fluid to the hose; a return tube for returning fluid from the hose to the cooling chamber; and a pump configured to move the cool fluid from the cooling chamber through the supply tube and hose in the liner.

In another aspect of the present invention, a cooling system comprises a liner for placement under a user; a hose interwoven throughout the liner; a cooling chamber for containing a cool fluid; a supply tube delivering the cool fluid to the hose; a return tube for returning fluid from the hose to the cooling chamber; a pump disposed inside the cooling chamber and configured to move the cool fluid from the cooling chamber through the supply tube and hose in the liner; a battery pack powering the pump; and a switch for controlling power from the battery pack to the pump.

In a further aspect of the present invention, a method for keeping a child cool in a seat comprises placing a liner under the child, the liner having a hose interwoven throughout the liner; pumping cool fluid with a pump from a cooling chamber, through a supply tube, into the hose, out a return tube and back into the cooling chamber; and controlling power from a battery pack to the pump by turning a switch on and off.

These and other features, aspects and advantages of the present invention will become better understood with reference to the following drawings, description and claims.

### BRIEF DESCRIPTION OF THE DRAWINGS

FIG. 1 is a perspective view of a cooling system used with a car seat according to an exemplary embodiment of the present invention;

FIG. 2 is a perspective view of the cooling system of FIG. 1;

FIG. 3 is a cross-sectional view of the cooling system as taken along line 3-3 of FIG. 2.

### DETAILED DESCRIPTION OF THE INVENTION

The following detailed description is of the best currently contemplated mode of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a liner for a car seat, stroller seat or other similar seat for a child that can have cool water circulating therethrough to help keep the child cool. The liner includes a tube disposed throughout the liner that is interconnected to a cooling chamber. A pump, typically disposed in the cooling chamber, can be used to circulate the cool fluid through the tube in the liner.

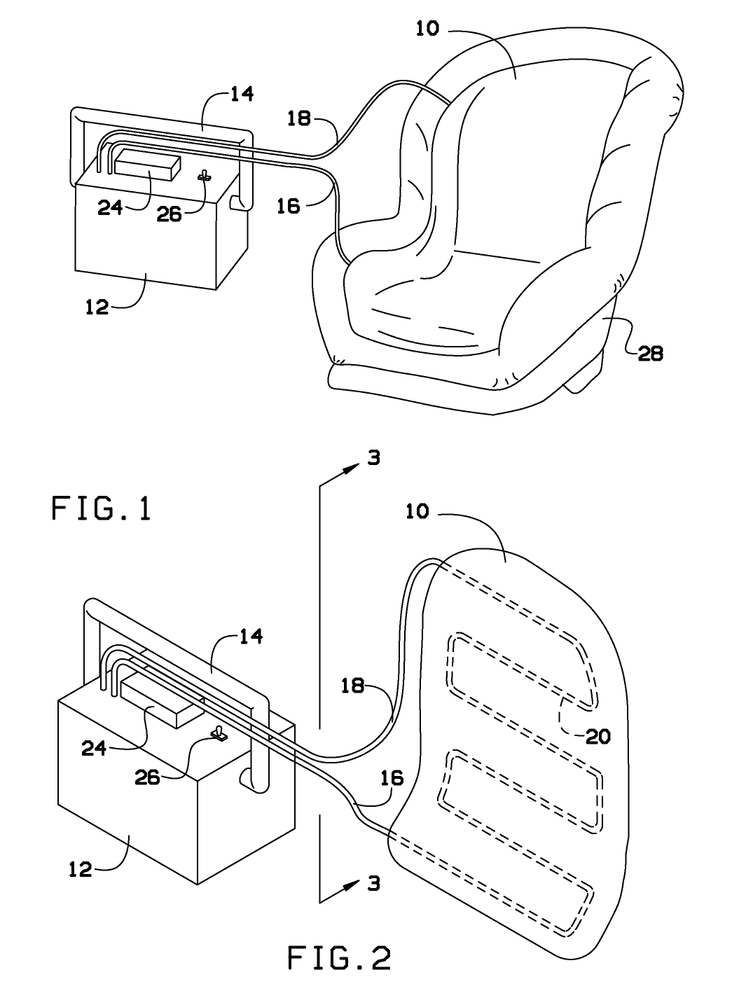

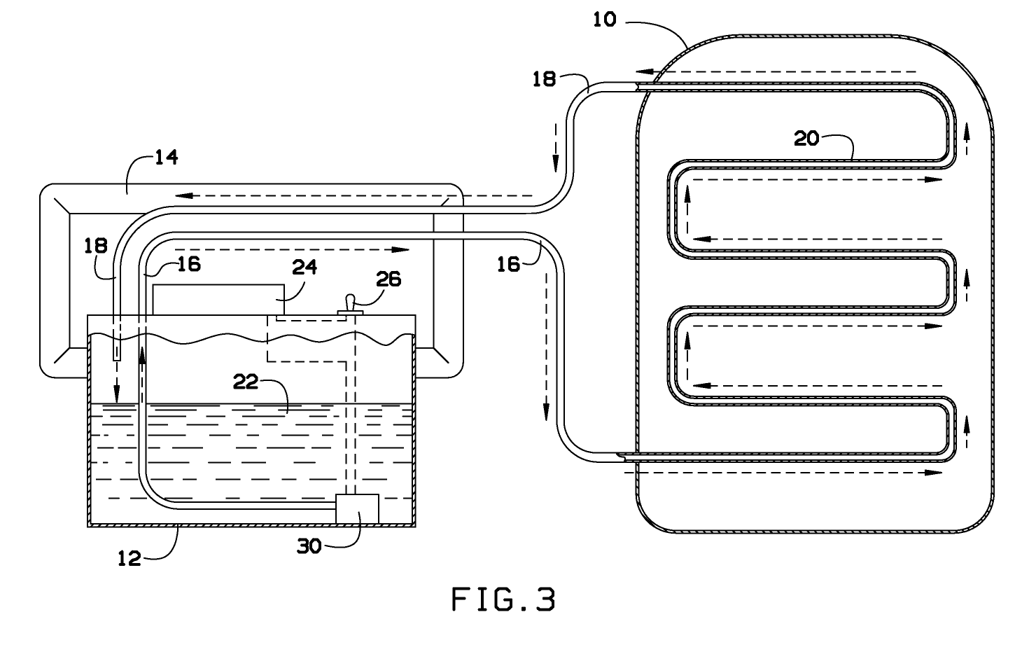

Referring now to FIGS. 1 through 3, a liner 10 can be sized to fit over or in a seat for a child. The seat could be a car seat, a stroller seat, a carrier seat, a bassinette, or the like. The liner 10 can include a liner interwoven hose 20 formed there in. The hose 20 can be looped throughout the liner to provide even cooling throughout the liner 10 when cool fluid is circulated through the hose 20. While FIGS. 2 and 3 show five turns in the hose 20, depending on the size of the hose 20 and the size of the liner 10, fewer or greater turns can be used to distribute the hose 20 throughout the liner 10.

A supply hose 16 can provide cool fluid to the hose 20 in the liner 10. A return hose 18 can receive fluid after passing through the hose 20 in the liner 10. The supply hose 16 and the return hose 18 can be of sufficient length to allow the cooling chamber 12 to be appropriately placed. For example, when used with a car seat 28, the cooling chamber 12 can be placed on the floor of the back seat while the liner 10 is disposed in the car seat 28.

The supply hose 16 and the return hose 20 can pass into a cooling chamber 12, such as an insulated cooler or the like. A pump 30 can be disposed in the cooling chamber 12 to move the cool fluid through the supply hose 16, to the hose 20 in the liner 10, through the return hose 18 and back to the cooling chamber 12. The cooling chamber 12 can include a handle 14 to carry the cooling chamber 12 along with the liner 10.

The pump 30 can be powered from various sources. For example, a battery pack 24 can be disposed with the cooling system, typically on top of the cooling chamber 12. The battery pack 24 can deliver power to a switch 26 which can be used to control power to the pump 30. In some embodiments, the pump 30 can be powered from an external source, such as being powered via car cigarette plug.

To use the cooling system of the present invention, a user can place cool fluid, such as ice water 22, into the cooling chamber 12. The user can place the liner 10 in a desired location and turn on the switch 26. The cool fluid will pass through the liner, via the hose 20, keeping a child placed over the liner 10 cool.

While the above describes the use of the cooling system for children, the cooling system could be used for any person, pet, or the like, that may have a desire to keep cool. The cooling system can be portable and used outside the home. Additionally, the cooling system could be used inside the home if such use is desired.

In some embodiments, the cooling system could include a sensor (not shown) to help prevent over cooling a child having the liner disposed thereunder. The sensor could, for example, check a surface temperature of the liner and turn off the pump if the boundary between the child and the liner become too cold. Once a suitable warmer temperature is attained, the pump can be re-started to circulate cool fluid again.

In some embodiments, a cooling coil (not shown) could be interconnected to the power supply and placed in the cooling fluid to keep the cooling fluid at a desired cool temperature. The cooling coil may be most useful in situations where ice may melt and there may be no way to get the fluid in the cooling chamber cool again.

It should be understood, of course, that the foregoing relates to exemplary embodiments of the invention and that modifications may be made without departing from the spirit and scope of the invention as set forth in the following claims.

What is claimed is:

1. A cooling system comprising:
a liner for placement under a user;
a hose interwoven throughout the liner;
a cooling chamber for containing a cool fluid;
a supply tube delivering the cool fluid to the hose;
a return tube for returning fluid from the hose to the cooling chamber; and
a pump configured to move the cool fluid from the cooling chamber through the supply tube and hose in the liner.

2. The cooling system of claim 1, wherein the cool fluid is ice water.

3. The cooling system of claim 1, wherein the pump is disposed inside the cooling chamber.

4. The cooling system of claim 1, wherein the cooling chamber is a cooler.

5. The cooling system of claim 1, further comprising a handle disposed on the cooling chamber.

6. The cooling system of claim 1, further comprising a battery pack for providing power to the pump.

7. The cooling system of claim 1, further comprising a switch for turning the pump on and off.

8. A cooling system comprising:
a liner for placement under a user;
a hose interwoven throughout the liner;
a cooling chamber for containing a cool fluid;
a supply tube delivering the cool fluid to the hose;
a return tube for returning fluid from the hose to the cooling chamber;
a pump disposed inside the cooling chamber and configured to move the cool fluid from the cooling chamber through the supply tube and hose in the liner;
a battery pack powering the pump; and
a switch for controlling power from the battery pack to the pump.

9. The cooling system of wherein the cooling chamber is a cooler with a handle disposed on the cooling chamber.

10. A method for keeping a child cool in a seat, the method comprising:
placing a liner under the child, the liner having a hose interwoven throughout the liner;
pumping cool fluid with a pump from a cooling chamber, through a supply tube, into the hose, out a return tube and back into the cooling chamber; and
controlling power from a battery pack to the pump by turning a switch on and off.
